(19) United States
(12) Patent Application Publication
(10) Pub. No.: US 2022/0148109 A1
(43) Pub. Date: May 12, 2022

(54) Method, Process and System for Matching Transaction Management and Revenue Asset Management

(71) Applicant: Chase Henry Hoyt, Los Angeles, CA (US)

(72) Inventor: Chase Henry Hoyt, Los Angeles, CA (US)

(21) Appl. No.: 17/094,548

(22) Filed: Nov. 10, 2020

(51) Int. Cl. G06Q 50/16; G06Q 30/06; G06Q 10/04; G06Q 40/02

(52) U.S. Cl. CPC G06Q 50/16; G06Q 30/0645; G06Q 50/01; G06Q 40/025; G06Q 10/04

(57) ABSTRACT

Software that allows and/or alerts buyers and lessees to search, view, book and bid on residential, commercial, workplace, vehicle and other leases prior to their lease expiration date. This system also allows buyers to search up-coming real estate listings to book or bid-on days, weeks, months and years in advance.

Software that collects and makes available from several scattered and discrete sources the multitude of disparate data that a real estate agent and/or real estate transaction professional needs to have immediately at hand to enable the agent or professional to immediately answer potential buyers,' sellers' and/or potential renters' questions about the real property in issue.

The program includes current real estate taxes, preferable mortgagor and mortgagee sources, title information, interest rates, parcel size, age of the property, past values as measured by dates and amounts of prior sales and rentals all together in a single source.

### INTRODUCTION

This invention includes software that provides a system to allow and/or alert buyers and lessees to search, view, book and bid on residential, commercial, workplace, vehicle and other leases prior to their lease expiration date. This system also allows buyers to search up-coming real estate listings to book or bid-on days, weeks, months and years in advance.

This invention conflates the several crucial components of business function that (a) relate to matching profiles for business, individuals, commercial and residential asset buyers and/or representatives to commercial and residential asset sellers and/or representatives, and to transaction, offer and cash flow planning and management, and tracking of leads, interactions and messages that have nowhere before been combined so that each and all can be analyzed, understood and implemented at one sitting, without the need to cull data from several disparate sources.

No other system, process, method or interface for allowing and/or alerting buyers and lessees to deadlines, and for matching profiles of individuals, businesses, buyers, sellers, representatives, customers and company or commercial or residential entity asset profiles is comprised of these methods, protocols and representations.

### FIELD OF THE INVENTION

Embodiments of the invention relate generally to computer and mobile matching systems, to a matching process system and method, to the field of computing, data processing and management, and more particularly, to systems, methods, and apparatuses for matching, processing and managing profiles of individuals, businesses, transactions, offers and recurring revenue asset information, loading priority of commercial and residential real estate sale and lease transactions and termination agreements, displaying commercial and residential real estate assets and management floor plans, provenance tracking and quality analysis for transaction, offer and revenue asset management data and business intelligence metrics.

I. Matching Systems

### BACKGROUND

Preferred embodiments of the invention relate generally to the field of computing, data processing and management, and more particularly to systems, methods and apparatuses for planning and tracking leads, interactions, messages, and processing and managing the leasing and sale-purchase of commercial and residential real property assets.

Certain types of computer and mobile matching systems and network protocols have been developed in order to allow an end user to search for another end user in order to accommodate an end user's networking, business and personal needs.

These systems and protocols may pertain to an end user's search for professional services, dating, person-finding services, social networking or job searches.

Certain types of computer and mobile systems have been developed in order to allow users the ability to swipe left to discard a match, and swipe right to approve a match. The swipe left, swipe right systems and protocols dictate a user's choice.

No aspect of the prior swiping mechanics is involved in this new invention. The prior swiping mechanics have been supplanted by this invention, which uses a different method, system and protocol for approving and discarding a match by and between the needs of user 1 and user 2.

### SUMMARY OF THE INVENTION

One aspect of the invention resides in a matching system and method different from swipe-left, swipe-right systems and protocols in order to discard a match or to approve a match. This new method has been developed in order to allow user 1 the ability to scroll through profiles for businesses or individuals, and/or commercial and residential property profiles and to pull a profile into one of a limited number of open positions in order to approve a match. This new method sends an invitation notification to user 2. When the invitation is approved by user 2, a match is approved and both user 1 and user 2 are permitted to message one another.

This method may be duplicated until all open positions are full. This unique method is designed so that it limits the number of matches for each user.

This method for profile matching has also been developed in order to allow user 1 the ability to discard a match differently from the swipe-left, swipe-right systems and protocols by replacing user 2 in the previously filled position with a new match to wit: by a card system.

In another aspect, a method for profile matching resides in the user receiving and choosing options in a series of preference and/or compatibility cards that are presented as a new protocol. The method allows a scoring system of user profiles for potential matches based on users' needs, wishes, commonality, preferences and comparisons of user profiles.

In another aspect, a method for profile matching resides in allowing the user to pull a profile into a waitlist queue. This method may be capable of optimizing match search results by reducing the amount of lost profiles and organizing profiles based on users' needs, wishes, commonality, preferences and comparisons of user profiles. This method may offer the ability to evaluate the attractiveness of potential deals and potential matches.

No other system and/or interface for matching user profiles is comprised of these methods, protocols and representations.

II. Transaction and Revenue Asset Management

### BACKGROUND

Innovations in products, sales to new customers or additional sales to existing customers, and other approaches to expanding the amount of market share controlled by an individual, company, brokerage or commercial entity have historically been primary drivers for revenue growth. A larger fraction of revenue and efficiency realized by an individual, company, brokerage or commercial entity, however, may be derived from planning and tracking of leads, transaction management and renewals and/or replacements of recurring revenue assets. This dimension has most often been an overlooked and unexploited opportunity. As used herein, a “recurring revenue asset” can generally refer to one or more maintenance applications and/or support agreements for software or hardware, pertinent to: commercial or residential real estate, to leases, and to service covered products, service contracts, subscription agreements, warranties, renewables, or the like. Many individuals, companies, brokerages or commercial entities fail to maximize realization of leads and revenue from transactions, offers and recurring revenue assets at least in part because management of such assets is not well supported by currently available approaches.

Currently available tools for managing leads, transactions, offers and counteroffers and recurring revenue are spread across customer relationship management (CRM) systems, partner relationship management (PRM) systems, data warehouses, entitlement systems, billing systems, spreadsheets, service contracts and other service assets. Transaction offer and recurring revenue management, however, presents a number of challenges that differ in substantial and important ways from the typical focus of the individual, company, brokerage and/or other commercial entity.

A typical sales process involves attracting customers, engaging leads, closing a sale or deal and moving on to a next customer. In contrast, transactions and offers and counteroffers may be multiple. Recurring revenue relationships are by definition repetitive. None of the above examples are efficiently tracked or managed by tools designed to support initial sales. In addition, the individual, company, brokerage and commercial entity's existing investments in sales personnel, sales processes, and information systems are typically directed to, (and are optimized and supported with appropriate technology for, achieving maximum revenue performance in the product or services sales business), but not in the planning and tracking of leads and efficient listing of transactions, offers and counter-offers and/or management of recurring revenue streams and the sales activities necessary to ensure that transactions, offers and counter-offers and related assets are maintained and even increased in value.

Optimizing and organizing leads, interactions, messages, transactions, offers and recurring revenue assets such as commercial and residential real estate transactions, (sale-purchase and property leasing) and service contracts and other service assets requires resolving challenges that span multiple areas of an individual, company, brokerage and commercial entity's operations. In today's fast moving and ever-changing market landscape, service revenues have become integrally related to the success of an individual, company, brokerage and commercial entity. The problem, however, is that as individuals, companies, brokerages and a variety of commercial entities begin to recognize the need for this updated focus, they run into a host of challenges for which they are not prepared. Those challenges include, for example: Missing the opportunity to re-engage with a lead or to re-lease a space or property due to expiration of the term of the lease, thus forfeiting the desired lease, or losing the lead.

### SUMMARY OF THE INVENTION

1. A method comprising: executing a multi-transaction, multi-offer, multi-tenant, and/or multi-lead database system within a host organization in support of multiple distinct customer organizations which utilize services provided by the host organization, wherein the multi-transaction, multi-offer, multi-tenant and/or multi-lead database system and/or the multi-populated seller-purchaser base includes processors and memory which are shared amongst the multiple distinct customer organizations;

Receiving, at a request and/or offer interface, incoming requests, bids, messages and/or offers from any of the multiple distinct customer entity organizations, (seller/purchaser or prospective lessor/lessee or lead) each operating as a separate transaction, offer and/or other aspect of the multi-transaction, multi-offer/counter-offer and/or multi-tenant database system, and returning responses to the multiple distinct customer organizations responsive to the incoming requests received;

Storing protected data of the multiple distinct customer organizations within one or more database systems, wherein the one or more database systems having the protected data stored therein are accessible via a database query interface of the host organization.

2. A system and method for tracking and managing current and projected revenue and or commissions. A customer relationship management system and dashboard with integrated applications and tools that enable individuals, companies, brokerages and commercial entities to maintain a relevant and cohesive customer experience throughout the transaction, offer and/or tenant lifecycle while tracking sales.

3. A system and method for displaying interactive floor plans for lease termination tracking and new lease on-boarding. Inherent in this concept is a system and method to personalize and optimize interactions with current and new customers through content management, bidding, lead tracking, messaging, chatbots, landing pages, ticketing, knowledge base and emails.

4. A system and method for organizing and priority and provenance listing for leads, bids, transactions, offers and counteroffers, recurring revenue assets, real property sale/purchase tracking and lease termination tracking and new lease on-boarding. Inherent in this concept is a system and method to personalize and optimize interactions with current and new customers through content management, bidding, messaging, chatbots, landing pages, ticketing, knowledge base and emails.

5. A system and method for content management and sales distribution of asset profiles. This system includes a method for updating, maintaining, displaying and sending or transmitting profiles, bids, messages, transactions, offers, counter-offers, and assets to current and new individuals customers, businesses and/or professionals. This system includes a method for updating and maintaining assets in a CRM database for each individual, company, brokerage, residential and commercial entity that displays and tracks leads, transactions, offers, counteroffers and assets, and captures its lead and customer activity throughout the customer lifecycle.

Illustrations and Graphics

Demonstrative illustrations and graphic depictions that will assist in describing and understanding the embodiments of the real estate leasing and real estate sales aspects of the invention are in preparation but have been constrained by the pervasive Coronavirus Disease—19 epidemic. They will be supplied to the Examiner as soon as they are completed. They are expected to be accomplished in final form and provided as a supplement to this Application by Sep. 29, 2021.

We claim:

1. A compact and simple system to allow and/or alert buyers and lessees to search, view, book and bid on residential, commercial, workplace, vehicle and other leases prior to their lease expiration date. This system also allows buyers to search up-coming real estate listings to book or bid-on days, weeks, months and years in advance.

2. A compact and simple system for matching buyers and sellers with real estate agents and real estate transaction professionals (such as: Mortgage lenders, loan officers, title companies, home inspectors, property managers, photographers, home staging, contractors, repair and fix-up professionals), and handling the protean data constantly evolving in the business of buying and selling commercial and residential real estate assets, and of leasing real estate and keeping occupancy at an optimum maximum in commercial and residential real estate assets.

3. A compact and simple system for keeping track of and handling the fluid and ever-changing needs and preferences of sellers and purchasers of commercial and residential real estate properties, which business is compounded in complexity by the credit requirements of purchasers and of potential mortgagees, by the occasional idiosyncrasies of title defects that emerge in title searches and the many other exigencies of selling and purchasing real property assets.
